(19) United States
(12) Patent Application Publication
(10) Pub. No.: US 2022/0408756 A1
(43) Pub. Date: Dec. 29, 2022

(54) POULTRY FEED AND DRINKING WATER COMPOSITION COMPRISING MONOMETHYLSILANETRIOL

(71) Applicant: RXW Group nv, Antwerpen (BE)

(72) Inventors: Karine CROIZET-BERGER, Court St Etienne (BE); Ivan COSTE-MANIERE, Grasse (FR); Nicolas RABASSO, Antony (FR)

(73) Assignee: RXW Group nv, Antwerpen (BE)

(21) Appl. No.: 17/621,319

(22) PCT Filed: Jun. 28, 2019
(86) PCT No.: PCT/EP2019/067472

§ 371 Date: Dec. 21, 2021

(51) Int. Cl. A23K 20/105; A23K 50/75

(52) U.S. Cl. CPC A23K 20/105; A23K 50/75

(57) ABSTRACT

The present invention provides a poultry feed or drinking water composition comprising monomethylsilanetriol (MMST), said poultry feed or drinking water composition for improving weight gain and gait score, and a method of breeding poultry by feeding to said poultry a feed or drinking water composition comprising MMST.

### TECHNICAL FIELD

The present invention relates to poultry feed and drinking water composition and methods of breeding poultry. More specifically, the present invention relates to the field of compositions for the improvement of growth profile of poultry in breeding farms, as well as the improvement of bone strength in poultry.

### INTRODUCTION

Poultry farming is the process of raising domesticated birds such as chickens, ducks, turkeys and geese for the purpose of farming meat or eggs for food. Poultry—mostly chickens—are farmed in great numbers. Farmers raise more than 50 billion chickens annually as a source of food, both for their meat and for their eggs. Chickens raised for eggs are usually called layers while chickens raised for meat are often called broilers.

Meat chickens, commonly called broilers, are floor-raised on litter such as wood shavings, peanut shells, and rice hulls, indoors in climate-controlled housing. Under modern farming methods, meat chickens reared indoors reach slaughter weight at 5 to 9 weeks of age, as they have been selectively bred to do so. In the first week of a broiler's life, it can grow up to 300 percent of its body size. A nine-week-old broiler averages over 9 pounds in body weight.

Broilers are raised in large, open structures known as grow-out houses. A farmer receives the birds from the hatchery at one day old. A grow-out consists of 5 to 9 weeks according to how big the kill plant wants the chickens to be. These houses are equipped with mechanical systems to deliver feed and water to the birds. Chicken feed consists primarily of corn and soybean meal with the addition of essential vitamins and minerals. No hormones or steroids are allowed in raising chickens. Two kilograms of grain must be fed to poultry to produce 1 kg of weight gain, much less than that required for pork or beef. Because dry bedding helps maintain flock health, most grow-out houses have enclosed watering systems (“nipple drinkers”) which reduce spillage.

Efficiency of farming of poultry, especially chickens, is of utmost importance, and is mainly achieved by feeding essential vitamins and minerals. EP 1 176 875 relates to the use of creatine or creatine salts as a fat substitute to be given to breeding animals and feeder animals. The creatine or creatine salts are used as a substitute for flesh meal, fish meal and/or antimicrobial performance enhancers, growth hormones as well as anabolic agents. EP 0 103 206 relates to a feed composition containing a dithia derivative. It was made clear that, by adding the dithia derivative to a feed and administering the feed composition to livestock, poultry, fish, etc., fat deposit particularly abdominal fat can be reduced with the whole body weight not being reduced, namely, carcass effectiveness can be enhanced and further, in poultry such as chicken or quail, strength of eggshell can be increased. WO 2005/120246 relates to the use of guanidino acetic acid and/or the salts thereof as an animal food additive, wherein in predominantly vegetarian diets, salts with hydrochloric acid, hydrogen bromide acid and phosphoric acid are particularly used. The use thereof takes places, particularly, in individual doses of 0.01 to 100 g/kg of animal food in the form of powder, granulates, pellets or capsules, and the animal food additive can also be taken with other physiologically active valuable substances. EP 0 125 322 describes a process for the use of ergotropic agent combinations in the breeding and the fattening of poultry, pigs and cattle, whereby 6-methyluracil and N-guanidino-N′-thioureido-p-benzoquinone-diimide are used as agents, the combinations of both the said agents containing each individual agent in amounts of 2 to 100 ppm in the feed, the total quantity of both agents not exceeding 125 ppm. EP 0 585 514 describes an animal feed and an additive thereto or to drinking water containing an antibiotic combination of 1 part by weight of gentamicin and 5 to 60 parts by weight of lincomycin or clindamycin, preferably in the form of pharmacologically acceptable acid addition salts thereof, for the prophylaxis and the therapy of infections and, consequently, for the increase of the gain in body weight in fattening animals. For the increase of the gain in body weight in poultry, the combination of gentamicin sulfate and lincomycin hydrochloride is very effective. WO 96/08977 discloses an agent for increasing the production of/in breeding and production animals in the poultry industry, which agent consists of at least one type of zanthophylles, is described. The preferred xanthophyll is astaxanthin. Also, a method of increasing the production of/in breeding and production animals in the poultry industry by administering an agent which consists of at least one type of xanthophylles, preferably astaxanthin, in the feed to animals is disclosed. Additionally the use of the agent, preferably astaxanthin, for increasing the production of/in breeding and production animals in the poultry industry by administering said agent in the feed to said animals is disclosed.

The present invention aims to provide new methods and compositions for breeding poultry which methods and compositions envision improved health and enhanced growth profile, as determined by enhanced weight profile.

### SUMMARY OF THE INVENTION

The current invention provides for at least one of the above mentioned problems by providing a poultry feed composition comprising a stable, bioavailable silicon complex.

In a first aspect, the present invention provides a poultry feed or drinking water composition comprising monomethylsilanetriol (MMST).

In a second aspect, the present invention provides a poultry feed or drinking water composition according to the first aspect of the invention, for improving body weight and daily weight gain in poultry. The inventors have surprisingly found that MMST improves poultry growth.

In a second aspect, the present invention provides a poultry feed or drinking water composition according to the first aspect of the invention, for medical use, for reducing lesions in particular footpad lesions. Furthermore the inventors suspect that MMST can be used for improving bone strength in poultry.

In a third aspect, the present invention provides a method of breeding poultry by feeding to said poultry a feed or drinking water composition comprising monomethylsilanetriol (MMST). The inventors have surprisingly found that feeding of said silicon complex induces an improved growth profile in the treated poultry. This is observed by means of improved weight gain per day.

In a fourth aspect, the present invention provides in a use of monomethylsilanetriol (MMST) for breeding poultry.

### DETAILED DESCRIPTION OF THE INVENTION

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise,” “comprising,” and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

The recitation of numerical ranges by endpoints includes all numbers and fractions subsumed within that range, as well as the recited endpoints. All percentages are to be understood as percentage by weight and are abbreviated as “% wt.”, unless otherwise defined or unless a different meaning is obvious to the person skilled in the art from its use and in the context wherein it is used.

The terms “additional therapeutically active compound” or “additional therapeutic agent”, as used in the context of the present disclosure, refers to the use or administration of a compound for an additional therapeutic use for a particular injury, disease, or disorder being treated. Such a compound, for example, could include one being used to treat an unrelated disease or disorder.

As use herein, the terms “administration of” and or “administering” a compound should be understood to mean providing a compound of the disclosure or a prodrug of a compound of the disclosure to a subject in need of treatment.

The term “antimicrobial agents” as used herein refers to any naturally-occurring, synthetic, or semi-synthetic compound or composition or mixture thereof, which is safe for human or animal use as practiced in the methods described herein, and is effective in killing or substantially inhibiting the growth of microbes. “Antimicrobial” as used herein, includes antibacterial, antifungal, and antiviral agents.

The term “silicic acid” is to be understood as is the general name for a family of chemical compounds containing the element silicon attached to oxide and hydroxyl groups. This family of compounds has the general formula [SiOₓ(OH)₄₋₂ₓ]ₙ. Examples include metasilicic acid (H₂SiO₃), i.e. the chain or cyclic [SiO(OH)₂]ₙ, orthosilicic acid (H₄SiO₄, i.e. Si(OH)₄ with calculated pKₐ₁=9.84, pKₐ₂=13.2 at 25° C.), disilicic acid (H₂Si₂O₅), i.e. the polymer [SiO_{1.5}(OH)]ₙ, and pyrosilicic acid (H₆Si₂O₇), i.e. O(Si(OH)₃)₂. Preferably, said silicic acid is orthosilicic acid.

The term “improve,” as used herein, refers to the ability of a compound, agent, or method to improve a condition, i.e. weight of poultry or bone strength, based on the context in which the term “improve” is used. Preferably, improvement is by at least 1%, more preferably by at least 2%, even more preferably by at least 5%, and most preferably, the condition is improved by at least 10%.

As used herein, “additional ingredients” include one or more of the following: excipients; surface active agents; dispersing agents; inert diluents; granulating and disintegrating agents; binding agents; lubricating agents; sweetening agents; flavouring agents; colouring agents; preservatives; physiologically degradable compositions such as gelatine; aqueous vehicles and solvents; oily vehicles and solvents; suspending agents; dispersing or wetting agents; emulsifying agents, demulcents; buffers; salts; thickening agents; fillers; emulsifying agents; antioxidants; antibiotics; antifungal agents; stabilizing agents; and pharmaceutically acceptable polymeric or hydrophobic materials. Other “additional ingredients” which may be included in the pharmaceutical compositions are known in the art and described, for example in Genaro, ed. (1985, Remington's Pharmaceutical Sciences, Mack Publishing Co., Easton, Pa.).

Other components such as preservatives, antioxidants, surfactants, absorption enhancers, viscosity enhancers or film forming polymers, bulking agents, diluents, flavouring agents, pH modifiers, sweeteners or taste-masking agents may also be incorporated into the composition. Suitable flavouring agents include mint, raspberry, licorice, orange, lemon, grapefruit, caramel, vanilla, cherry grape flavours and combinations thereof. Suitable pH modifiers include, but are not limited to, citric acid, tartaric acid, phosphoric acid, hydrochloric acid, maleic acid and sodium hydroxide. Suitable sweeteners include, but are not limited to, aspartame, acesulfame K and thaumatin. Suitable taste-masking agents include, but are not limited to, sodium bicarbonate, vanilla, ion-exchange resins, cyclodextrin inclusion compounds and adsorbates.

Poultry Feed or Drinking Water Composition

In a first aspect, the present invention provides a poultry feed or drinking water composition comprising monomethylsilanetriol (MMST). The inventors have surprisingly found that feeding of said silicon complex induces an improved growth profile in the treated poultry. This is observed by means of improved weight gain per day. This means that i.e. chickens reach higher target weights for slaughter. Also, this means that i.e. chickens reach the expected weight for slaughter much earlier, i.e. after 40 days instead of 50 or even 60 days. Also, it was found that the weight growth of the poultry enhanced faster compared to poultry which was not fed with the silicon complex composition of the invention.

In a preferred embodiment, the present invention provides a poultry drinking water composition according to the first aspect of the invention. A drinking water is preferred since a solution of the silicon mixture can easily be added to a drinking water supply. The complex is easily and homogeneously mixed in a liquid, aqueous solution to the desired concentration, as outlined below.

In a preferred embodiment, the present invention provides a poultry feed or drinking water composition according to the first aspect of the invention, wherein said composition comprises silicon in an amount of at least 10 μg per kg of composition as determined by ICP-AES, preferably at least 20 μg per kg, at least 30 μg per kg, at least 40 μg per kg, at least 50 μg per kg, at least 60 μg per kg, at least 70 μg per kg, at least 80 μg per kg, at least 90 μg per kg, or even at least 100 μg per kg. Such minimal amount yield the preferred growth improvement in poultry. Preferably, said composition comprises silicon in an amount of at most 1.000.000 μg per kg of composition, preferably at most 1.000.000 μg per kg, more preferably at most 900.000 μg per kg, more preferably at most 800.000 μg per kg, more preferably at most 700.000 μg per kg, more preferably at most 600.000 μg per kg, more preferably at most 500.000 μg per kg, more preferably at most 400.000 μg per kg, more preferably at most 300.000 μg per kg, more preferably at most 200.000 μg per kg, more preferably or even at most 100.000 μg per kg of composition. Higher concentrations do not provide for further enhanced weight growth profiles, thus resulting in lower efficiency of the consumed silicon complex.

In a preferred embodiment, the present invention provides a poultry feed or drinking water composition according to the first aspect of the invention, wherein said composition comprises silicon in an amount of 100 μg per kg of composition to 100.000 μg per kg of composition as determined by ICP-AES. Preferably, said composition comprises silicon in an amount of at least 100 μg per kg of composition, at least 125 μg per kg, at least 150 μg per kg, at least 200 μg per kg, at least 250 μg per kg, at least 300 μg per kg, at least 350 μg per kg, at least 400 μg per kg, or even at least 500 μg per kg. Preferably, said composition comprises silicon in an amount of at most 100.000 μg per kg of composition, preferably at most 100.000 μg per kg, at most 90.000 μg per kg, at most 80.000 μg per kg, at most 70.000 μg per kg, at most 60.000 μg per kg, at most 50.000 μg per kg, at most 40.000 μg per kg, at most 30.000 μg per kg, at most 20.000 μg per kg, at most 10.000 μg per kg, at most 50.000 μg per kg of composition.

In a preferred embodiment, the present invention provides a poultry feed or drinking water composition according to the first aspect of the invention, wherein said composition comprises silicon in an amount of 500 μg per kg of composition to 2.500 μg per kg of composition as determined by ICP-AES. Preferred concentrations are 500 μg per kg composition, 600 μg per kg composition, 700 μg per kg composition, 800 μg per kg composition, 900 μg per kg composition, 1.000 μg per kg composition, 1.100 μg per kg composition, 1.200 μg per kg composition, 1.300 μg per kg composition, 1.400 μg per kg composition, 1.500 μg per kg composition, 1.600 μg per kg composition, 1.700 μg per kg composition, 1.800 μg per kg composition, 1.900 μg per kg composition, 2.000 μg per kg composition, 2.100 μg per kg composition, 2.200 μg per kg composition, 2.300 μg per kg composition, 2.400 μg per kg composition or 2.500 μg per kg composition, or any concentration there in between.

In a more preferred embodiment, the present invention provides a poultry feed or drinking water composition according to the first aspect of the invention, wherein said composition comprises MMST in drinking water in an amount of at least 0.01 mg/l. Preferably, said composition comprises silicon in an amount of at least 0.02 mg/l, at least 0.03 mg/l, at least 0.04 mg/l, at least 0.05 mg/l, at least 0.06 mg/l, at least 0.07 mg/l, at least 0.08 mg/l, at least 0.09 mg/l, at least 0.10 mg/l, at least 0.12 mg/l, at least 0.15 mg/l, at least 0.17 mg/l, at least 0.19 mg/l, at least 0.20 mg/l. Preferably, said drinking water comprises MMST in an amount of at most 500 mg/l, more preferably at most 450 mg/l, more preferably at most 400 mg/l, preferably at most 350 mg/l, more preferably at most 300 mg/l, more preferably at most 250 mg/l, more preferably at most 200 mg/l, more preferably at most 190 mg/l, more preferably at most preferably at most 150 mg/l, more preferably at most 100 mg/l, more preferably at most 50 mg/l, more preferably at most 40 mg/l, more preferably at most 30 mg/l, more preferably at most 25 mg/l, more preferably at most 20 mg/l, more preferably at most 15 mg/l, more preferably at most 10 mg/l, preferably at most 5 mg/l, most preferably at most 3 mg/l. Higher concentrations do not provide for further enhanced weight growth profiles, thus resulting in lower efficiency of the consumed MMST. In a particular preferred embodiment, the present invention comprises MMST in drinking water in an amount between 0.9 and 18 mg/l.

The inventors have found that monomethylsilanetriol provides improved results. This organosilicon compound is highly bioavailable. Furthermore, MMST is sufficiently stable in water at low concentrations, unlike orthosilicic acid which tends to form silica gel due to polymerization of orthosilicic acid in water, thereby decreasing its bioavailability. MMST can advantageously be used without stabilizers in silicon equivalent concentrations up to 300 mg/l. The stability of MMST is dependent on concentration and declines at higher concentrations. The stability can be enhanced by the use of stabilizing agents.

In a preferred embodiment, the present invention provides a poultry feed or drinking water composition according to the first aspect of the invention, wherein said stabilizing agent is selected from the group comprising phenolic acids, phenols, aldehyde derivatives of phenolic acids, cinnamic aldehydes, coumarins, naphthoquinones, flavonoids, stilbenes and mixtures of one or more of the aforementioned, preferably wherein said stabilizing agent is 4-hydroxy-3-methoxybenzaldehyde. The stabilizer is preferably a phenolic or polyphenolic compound and the following compounds, not limited thereto, may be exemplified: phenolic acids, such as 3-4-5-trihydroxybenzoic acid, 4-hydroxy-3-acid; methoxybenzoic acid, 3-4-dihydroxybenzoic acid, 4-hydroxy-3,5-dimethoxybenzoic acid, 2-hydroxybenzoic acid, 2-5-dihydroxybenzoic acid, 3-(4-hydroxyphenyl) acid 2-propenoic acid, 3-(3,4-dihydroxyphenyl) prop-2-enoic acid, 3-(4-hydroxy-3-methoxyphenyl) prop-2-enoic acid, 3-(4-hydroxy-3,5-dimethoxyphenyl)-prop-2-enoic acid, (R)-a-[[3-(3,4-dihydroxyphenyl)-1-oxo-2E-propenyl]-oxy]-3,4-dihydroxybenzenepropanoic acid, etc.; simple phenols, such as benzene-1,2-diol, benzene-1,3-diol, 2-isopropyl-5-methylphenol; phenylbutanone, such as 1-(4-hydroxyphenyl)-3-butanone; aldehyde derivatives of phenolic acids, such as 4-hydroxy-3-methoxybenzaldehyde, etc.; cinnamic aldehydes, such as 4-allyl-2-methoxyphenol, 2-methoxy-4-propenylphenol, etc.; coumarins, such as 7-hydroxychromen-2-one, 6,7-dihydroxychromen-2-one, etc.; naphthoquinones, such as 5-hydroxy-1,4-naphthoquinone, etc.; flavonoids, such as catechin (2-(3,4-dihydroxyphenyl) chroman-3,5,7-triol) and epicatechin (EC), epigallocatechin (EGC), epicatechin gallate (ECG), epigallocatechin gallate (EGCG), kaempferol, quercetol, luteolin, etc.; stilbenes, such as resveratrol, pinosylvin, piceatannol, pterostilbene, etc. Preferred stabilizers are 4-hydroxy-3-methoxybenzaldehyde, 1-(4-hydroxyphenyl)-3-butanone, 2-hydroxybenzoic acid, and (2-(3,4-dihydroxyphenyl)-chromane-3,5,7-triol). In a more preferred embodiment, the present invention provides a composition according to the first aspect of the invention, wherein said stabilizing agent is 4-hydroxy-3-methoxybenzaldehyde.

In a preferred embodiment, the present invention provides a poultry feed or drinking water composition according to the first aspect of the invention, further comprising one or more therapeutic agents, preferably selected from the group consisting of vitamins, antimicrobial agents, disinfectants, fungicides, anti-inflammatories, plant extracts, antibacterial agents, antifungal agents, antiviral agents, antibiotics.

Poultry Feed or Drinking Water Compositions for Medical Use

In a second aspect, the present invention provides a poultry feed or drinking water composition according to the first aspect of the invention, for medical use, preferably for reducing lesions in particular footpad lesions in poultry. Furthermore the inventors deem that MMST can be used for improving bone strength in poultry. The inventors have surprisingly found that in addition to improved weight gain, the treated poultry population shows improved skin lesions as well as minor improvements in bone strength. The silicon supplement was shown to improve the average gait score of poultry. Without being bound by theory, it is believed that poultry with a better gait score has a higher daily weight gain and thus a higher body weight after a set time.

In a preferred embodiment, the present invention provides a poultry feed or drinking water composition according to the second aspect of the invention, whereby said poultry is chicken, preferably broiler chicken. Preferably, said chicken is between 1 and 60 days of age, more preferably between 1 and 40 days.

Preferred Compositions

In a preferred embodiment, the present invention provides a composition according to the first or second aspect of the invention, whereby said composition is a drinking water composition and whereby said composition comprises MMST in an amount of 0.05 to 150 mg/l, preferably 0.05 to 100 mg/l, more preferably 0.10 to 50 mg/l, more preferably 0.10 to 25 mg/l, more preferably 0.10 to 10 mg/l, most preferably 0.15 to 5 mg/l. Addition of the silicon supplement to drinking water allows for convenient mixing and dosing, in particular in comparison to mixing supplements into feedstock.

In a preferred embodiment, the present invention provides a composition according to the first or the second aspect of the invention, further comprising one or more therapeutic agents. Preferably, said additional therapeutic agent is selected from the group consisting of vitamins, antimicrobial agents, disinfectants, fungicides, anti-inflammatories, wound care products, wound healing agents, plant extracts, animal extracts, cell extracts, antibacterial agents, antifungal agents, antiviral agents, antibiotics. Several preferred embodiments include use of any therapeutic molecule including any pharmaceutical or drug. Examples of pharmaceuticals include sedatives and sleep inducers, antiallergics, antiarthritics, appetite suppressants, muscle relaxants, vitamins, antimicrobial agents, antacids, antiseptics, diuretics, disinfectants, fungicides, ectoparasiticides, antiparasitics, antioxidants, vitamins, cosmetics, anti-inflammatories, wound care products, wound healing agents, plant extracts, emollients, antibacterial agents, antifungal agents, antiviral agents, antibiotics. A list of the types of drugs, and specific drugs within categories which are encompassed within the invention is provided below and are intended be non-limiting examples. Antimicrobial agents include: silver sulfadiazine, Nystatin, Nystatin/triamcinolone, Bacitracin, nitrofurazone, nitrofurantoin, a polymyxin (e.g., Colistin, Surfactin, Polymyxin E, and Polymyxin B), doxycycline, antimicrobial peptides (e.g., natural and synthetic origin), Neosporin (i.e., Bacitracin, Polymyxin B, and Neomycin), Polysporin (i.e., Bacitracin and Polymyxin B). Additional antimicrobials include topical antimicrobials (i.e., antiseptics), examples of which include silver salts, iodine, benzalkonium chloride, alcohol, hydrogen peroxide, and chlorhexidine. Anti-inflammatory: Alclofenac; Alclometasone Dipropionate; Algestone Acetonide; Alpha Amylase; Amcinafal; Amcinafide; Amfenac Sodium; Amiprilose Hydrochloride; Anakinra; Anirolac; Anitrazafen; Apazone; Balsalazide Disodium; Bendazac; Benoxaprofen; Benzydamine Hydrochloride; Bromelains; Broperamole; Budesonide; Carprofen; Cicloprofen; Cintazone; Cliprofen; Clobetasol Propionate; Clobetasone Butyrate; Clopirac; Cloticasone Propionate; Cormethasone Acetate; Cortodoxone; Deflazacort; Desonide; Desoximetasone; Dexamethasone Dipropionate; Diclofenac Potassium; Diclofenac Sodium; Diflorasone Diacetate; Diflumidone Sodium; Diflunisal; Difluprednate; Diftalone; Dimethyl Sulfoxide; Drocinonide; Endrysone; Enlimomab; Enolicam Sodium; Epirizole; Etodolac; Etofenamate; Felbinac; Fenamole; Fenbufen; Fenclofenac; Fenclorac; Fendosal; Fenpipalone; Fentiazac; Flazalone; Fluazacort; Flufenamic Acid; Flumizole; Flunisolide Acetate; Flunixin; Flunixin Meglumine; Fluocortin Butyl; Fluorometholone Acetate; Fluquazone; Flurbiprofen; Fluretofen; Fluticasone Propionate; Furaprofen; Furobufen; Halcinonide; Halobetasol Propionate; Halopredone Acetate; Ibufenac; Ibuprofen; Ibuprofen Aluminum; Ibuprofen Piconol; Ilonidap; Indomethacin; Indomethacin Sodium; Indoprofen; Indoxole; Intrazole; Isoflupredone Acetate; Isoxepac; Isoxicam; Ketoprofen; Lofemizole Hydrochloride; Lornoxicam; Loteprednol Etabonate; Meclofenamate Sodium; Meclofenamic Acid; Meclorisone Dibutyrate; Mefenamic Acid; Mesalamine; Meseclazone; Methylprednisolone Suleptanate; Momiflumate; Nabumetone; Naproxen; Naproxen Sodium; Naproxol; Nimazone; Olsalazine Sodium; Orgotein; Orpanoxin; Oxaprozin; Oxyphenbutazone; Paranyline Hydrochloride; Pentosan Polysulfate Sodium; Phenbutazone Sodium Glycerate; Pirfenidone; Piroxicam; Piroxicam Cinnamate; Piroxicam Olamine; Pirprofen; Prednazate; Prifelone; Prodolic Acid; Proquazone; Proxazole; Proxazole Citrate; Rimexolone; Romazarit; Salcolex; Salnacedin; Salsalate; Sanguinarium Chloride; Seclazone; Sermetacin; Sudoxicam; Sulindac; Suprofen; Talmetacin; Talniflumate; Talosalate; Tebufelone; Tenidap; Tenidap Sodium; Tenoxicam; Tesicam; Tesimide; Tetrydamine; Tiopinac; Tixocortol Pivalate; Tolmetin; Tolmetin Sodium; Triclonide; Triflumidate; Zidometacin; Zomepirac Sodium.

Method for Breeding Poultry

In a third aspect, the present invention provides a method of breeding poultry by feeding to said poultry a feed or drinking water composition comprising monomethylsilanetriol (MMST). Monomethylsilanetriol is a stable, bioavailable silicon compound.

The inventors have surprisingly found that feeding of said silicon complex induces an improved growth profile in the treated poultry. This is observed by means of improved weight gain per day. This means that i.e. chickens reach higher target weights for slaughter. Also, this means that i.e. chickens reach the expected weight for slaughter much earlier, i.e. after 40 days instead of 50 or even 60 days. Also, it was found that the weight growth of the poultry enhanced much faster compared to poultry which was not fed with the silicon complex composition of the invention.

In a preferred embodiment, the present invention provides method according to the third aspect of the invention, wherein said silicon complex is comprised in drinking water. A drinking water is preferred since a solution of the silicon complex can easily be added to a drinking water supply. The complex is easily and homogeneously mixed in a liquid, aqueous solution to the desired concentration, as outlined below.

In a preferred embodiment, the present invention provides method according to the third aspect of the invention, wherein said composition comprises silicon in an amount of at least 10 μg per kg of composition per kg of composition as determined by ICP-AES, preferably at least 20 μg per kg, at least 30 μg per kg, at least 40 μg per kg, at least 50 μg per kg, at least 60 μg per kg, at least 70 μg per kg, at least 80 μg per kg, at least 90 μg per kg, or even at least 100 μg per kg. Such minimal amounts yield the preferred growth improvement in poultry. Preferably, said composition comprises silicon in an amount of at most 1.000.000 μg per kg of composition, preferably at most 1.000.000 μg per kg, at most 900.000 μg per kg, at most 800.000 μg per kg, at most 700.000 μg per kg, at most 600.000 μg per kg, at most 500.000 μg per kg, at most 400.000 μg per kg, at most 300.000 μg per kg, at most 200.000 μg per kg, or even at most 100.000 μg per kg of composition. Higher concentrations do not provide for further enhanced weight growth profiles, thus resulting in lower efficiency of the consumed silicon complex.

In a preferred embodiment, the present invention provides method according to the third aspect of the invention, wherein said composition comprises silicon in an amount of 100 μg per kg of composition to 100.000 μg per kg of composition as determined by ICP-AES. Preferably, said composition comprises silicon in an amount of at least 100 μg per kg of composition, at least 125 μg per kg, at least 150 μg per kg, at least 200 μg per kg, at least 250 μg per kg, at least 300 μg per kg, at least 350 μg per kg, at least 400 μg per kg, or even at least 500 μg per kg. Preferably, said composition comprises silicon in an amount of at most 100.000 μg per kg of composition, preferably at most 100.000 μg per kg, at most 90.000 μg per kg, at most 80.000 μg per kg, at most 70.000 μg per kg, at most 60.000 μg per kg, at most 50.000 μg per kg, at most 40.000 μg per kg, at most 30.000 μg per kg, at most 20.000 μg per kg, at most 10.000 μg per kg, at most 50.000 μg per kg of composition.

In a preferred embodiment, the present invention provides method according to the third aspect of the invention, wherein said composition comprises silicon in an amount of 500 μg per kg of composition to 2.500 μg per kg of composition as determined by ICP-AES. Preferred concentrations are 500 μg per kg composition, 600 μg per kg composition, 700 μg per kg composition, 800 μg per kg composition, 900 μg per kg composition, 1.000 μg per kg composition, 1.100 μg per kg composition, 1.200 μg per kg composition, 1.300 μg per kg composition, 1.400 μg per kg composition, 1.500 μg per kg composition, 1.600 μg per kg composition, 1.700 μg per kg composition, 1.800 μg per kg composition, 1.900 μg per kg composition, 2.000 μg per kg composition, 2.100 μg per kg composition, 2.200 μg per kg composition, 2.300 μg per kg composition, 2.400 μg per kg composition or 2.500 μg per kg composition, or any concentration there in between.

In a preferred embodiment, the present invention provides method according to the third aspect of the invention, wherein said poultry is chicken and wherein said chicken is between 1 and 60 days of age, preferably between 1 and 40 days.

In a preferred embodiment, the present invention provides method according to the third aspect of the invention, further comprising the step of feeding one or more therapeutic agents, preferably selected from the group consisting of vitamins, antimicrobial agents, disinfectants, fungicides, anti-inflammatories, plant extracts, antibacterial agents, antifungal agents, antiviral agents, antibiotics.

Use

In a fourth aspect, the present invention provides in a use of monomethylsilanetriol (MMST) for breeding poultry.

### EXAMPLES

In the following examples are intended to further clarify the present invention, and are nowhere intended to limit the scope of the present invention.

The following abbreviations are used herein:

Examples: Controlled Study of MMST.

A study was conducted to investigate the effect of silicium supplementation in drinking water of broiler chicken on their performance, locomotive system, skin healing and bone formation. Silicium was supplemented in 2 treatment groups. A third group was used as control and not treated with silicium. Silicium-monomethylsilanetriol (Si-MMST) was administrated at 2 different concentrations. More specific, Si-MMST was added to drinking water at 0.3 mg/l and 1.48 mg/l. These refer to the final silicium concentrations as measured by ICP-AES. Birds were moreover reared on humidified bedding material to simulate bad housing conditions and induce mild locomotive and skin complications. During the study, performance was assessed by weighing birds and monitoring feed intake on specific time points, separating the study in a starter, grower and finisher period. Additionally, mobility of the birds was assessed at the end of the grower (D33) and finisher period (D41) by means of gait scoring (Kestin et al., 1992). At the end of the trial (D41), footpad and chest lesions, femur head necrosis and tibia dyschondroplasy were assessed by qualified veterinarians, which also isolated 1 tibia per bird for bone strength and composition analysis. The main results of this study are summarizes in table 1.

Mortality did not exceed 5% of the birds for this study and therefore evaluated as a natural loss. Supplementation of 1.433 mg/l Si-MMST to the drinking water of birds significantly increased body weight on day 41 and DWG over the complete study period (D0-D41). This however did not lead to an improved feed conversion ratio in this treatment group. The footpad lesions were significantly less severe on day 41 in birds supplemented with 0.3 mg/l Si-MMST in their drinking water, with tendencies to improvement in the other silicium treatment group. This was also reflected in the impaired gait scoring of birds supplemented with MMST. Rearing conditions were however too mild to induce clear skin lesion. Analysis of the first 50 bones hinted to improvement of strength and enrichment of composition, but was not conclusive. The differences in fracture force, maximum force, stiffness and manganese content of the bone between the UC and 1.48 mg/l Si-MMST treated groups did not show to be significant in this study. However, improvements were noted and a lack of statistical significance may be attributed to the number of measurements.

Overall, supplementation of 1.48 mg/l Si-MMST formulation in the drinking water of chicken during rearing shows most potential in amelioration of performance and mobility during this study, with a significant increase in BW at the end of the study and a significant increase in DWG over the complete study period and indications but no significant results on improvement of bone strength and composition compared to UC.

TABLE 1
Summary of study results

| | BW | DWG | FCR | Gait | | Bone | Fract. | Max | | | |
|---|---|---|---|---|---|---|---|---|---|---|---|
| | D41 | D0-41 | D0- | score | FP | weight | force | force | Stiffn. | Mn | P |
| Groupname | (g) | (g) | 41 | D41 | lesion | (g) | (N) | (N) | (N/mm) | (mg/kg) | (%) |
| UC | 2622 | 62.8 | 1.8 | 0.72 | 1.31 | 12.7 | 333.5 | 382.0 | 147.9 | 7.5 | 17.8 |
| Si-MMST (0.3 mg/l) | 2636 | 63.1 | 1.9 | 0.39* | 0.9* | 12.3 | 360.7 | 372.5 | 148.8 | 7.4 | 17.8 |
| Si-MMST (1.48 mg/l) | 2775* | 66.5* | 1.8 | 0.46* | 1.04 | 13.2 | 400.6 | 409.6 | 164.3 | 8.2 | 17.6 |

*p-value < 0.05

The feed was purchased from a commercial feed mill. Water supply was ad libitum with (supplemented) potable drinking water originating from a well watering system.

As 1 of the 2 tibia needs to be isolated unimpaired, tibia dyschondroplasy could only be scored unilateral. Therefore the tibia dyschondroplasy scoring ranges from 0 to 2 instead of 0 to 5.

Animal Body Weight and Daily Weight Gain

Average daily weight gain (DWG) for example in starter period (D0-D14) was calculated, using following formula:

$$Average daily weight gain = \frac{( Weight bird D 14 - weight bird D 0 )}{14 days study period}$$

Similar formula was used to calculate the DWG for all the experimental periods. Table 2 and 3 respectively show the body weight (BW) and daily weight gain (DWG) for the different time points or experimental periods.

Only on day 41 animals reared with 1.48 mg/l Si-MMST in drinking water showed a significant increased BW being 2.775 kg, compared to the UC weighing on average 2.622 kg. Moreover this resulted in a significantly higher DWG of 66.5 g in birds reared with 1.48 mg/l Si-MMST in drinking water compared to 62.8 g in the UC.

TABLE 2
Individual body weight of birds at different time points (g)

| | BW D0 | | | BW D14 | | | BW D33 | | | BW D41 | | |
|---|---|---|---|---|---|---|---|---|---|---|---|---|
| | | | p- | | | p- | | | p- | | | p- |
| Groupname | n | LSM | value | n | LSM | value | n | LSM | value | n | LSM | value |
| UC | 50 | 47 | Ref. | 50 | 412 | Ref. | 50 | 1820 | Ref. | 49 | 2622 | Ref. |
| Si-MMST 1 | 50 | 48 | 0.294 | 50 | 407 | 0.577 | 50 | 1748 | 0.275 | 50 | 2636 | 0.845 |
| Si-MMST 2 | 49 | 48 | 0.515 | 49 | 410 | 0.786 | 48 | 1883 | 0.344 | 45 | 2775 | 0.047 |

TABLE 3
Average daily weight gain per bird in different study periods (g)

| | DWG D0-14 | | | DWG D14-33 | | | DWG D33-41 | | | DWG D0-41 | | |
|---|---|---|---|---|---|---|---|---|---|---|---|---|
| | | | p- | | | p- | | | p- | | | p- |
| Groupname | n | LSM | value | n | LSM | value | n | LSM | value | n | LSM | value |
| UC | 50 | 26.1 | Ref. | 50 | 74.1 | Ref. | 49 | 98.9 | Ref. | 49 | 62.8 | Ref. |
| Si-MMST 1 | 50 | 25.6 | 0.533 | 50 | 70.6 | 0.298 | 50 | 111.1 | 0.199 | 50 | 63.1 | 0.853 |
| Si-MMST 2 | 49 | 25.8 | 0.755 | 48 | 77.6 | 0.304 | 45 | 111.1 | 0.201 | 45 | 66.5 | 0.047 |

Feed Consumption and Feed Conversion

The total feed weight was measured per pen when switching between feed compositions. The feed weight (“Feed IN”) was measured and recorded on D0, D14, D33 and D41. Two pens during grower period and all pens during finisher period were supplemented with extra feed to enable at libitum feeding. This extra feed was also weighed and recorded as “Feed IN”. The remaining feed in each pen (“Feed OUT”) was weighed and recorded on D14, D33 and D41. The feed intake (=difference in feed weight at beginning and the end of the experimental period) was calculated for each group per study period. The average daily feed intake (DFI) was calculated for the experimental period using the feed intake data by using following formula:

$$Average daily feed intake = \frac{( FEED IN - FEED OUT )}{total number of bird days}$$

The Feed Conversion Ratio (FCR) was calculated for each of the above mentioned study periods, using following formula:

$$Feed conversion ratio = \frac{Average daily feed intake}{Average daily weight gain at pen level}$$

Table 4 and 5 show the average DFI and FCR for all treatment groups during the different study periods. No significant differences were observed between the different treatment groups in any of the study periods either for DFI or FCR. However, daily feed intake for MMST supplemented treatment groups were higher than the control in all study periods, and thus across the entire study period D0-D41. The inventors suspect that MMST is particularly well suited for increasing body weight and body weight gain in poultry.

TABLE 4
Average daily feed intake per bird
during different study periods (g)

| | DFI D0-14 | | DFI D14-33 | | DFI D33-41 | | DFI D0-41 | |
|---|---|---|---|---|---|---|---|---|
| | | p- | | p- | | p- | | p- |
| Groupname | Mean | value | Mean | value | Mean | value | Mean | value |
| UC | 23.6 | Ref. | 137.8 | Ref. | 199.8 | Ref. | 113.6 | Ref. |
| Si-MMST 1 | 24.9 | 0.17 | 141.2 | 0.64 | 207.0 | 0.52 | 117.4 | 0.34 |
| Si-MMST 2 | 25.0 | 0.17 | 132.7 | 0.49 | 218.5 | 0.1 | 114.4 | 0.83 |

TABLE 5
Average feed conversion ratio during different study periods

| | FCR D0-14 | | FCR D14-33 | | FCR D33-41 | | FCR D0-41 | |
|---|---|---|---|---|---|---|---|---|
| | | p- | | p- | | p- | | p- |
| Groupname | Mean | value | Mean | value | Mean | value | Mean | value |
| UC | 0.9 | Ref. | 1.9 | Ref. | 2.1 | Ref. | 1.8 | Ref. |
| Si-MMST 1 | 1.0 | 0.08 | 2.0 | 0.18 | 1.9 | 0.3 | 1.9 | 0.59 |
| Si-MMST 2 | 1.0 | 0.14 | 1.7 | 0.23 | 2.1 | 0.69 | 1.8 | 0.53 |

Gait Scoring

On D33 and D41, mobility of the birds was evaluated individually by using the gait scoring chart as described by Kestin et al., 1992. Gait scores were assessed by to independent blinded persons and averaged over these two to obtain a more objective measure of mobility. Table 6 demonstrates the mean gait scores per treatment group on day 33 and day 41.

Even though mean gait scores of the UC group are not very high, there is a significant improvement of mean gait scores in birds reared with either 0.3 or 1.48 mg/l Si-MMST supplementation to the drinking water. Both these groups showed a significantly lower mean gait score compared to UC on day 41. This suggests that the supplementation of MMST was beneficial for improving broiler mobility in this study.

TABLE 6
Average gait score per treatment
group on day 33 and day 41

| | Gait score D33 | | Gait score D41 | |
|---|---|---|---|---|
| Groupname | Mean | p-value | Mean | p-value |
| UC | 0.50 | Ref. | 0.72 | Ref. |
| Si-MMST 1 | 0.26 | 0.007 | 0.39 | 0.002 |
| Si-MMST 2 | 0.27 | 0.011 | 0.46 | 0.018 |

Footpad and Chest Lesion Scores

On D41, all birds were scored for footpad lesions and chest skin discoloration and lesions as demonstrated in table 7. Supplementation of 0.3 mg/l Si-MMST to the drinking water, significantly reduced the induction of footpad lesions in birds reared on humid bedding material. More specific, the average footpad lesion score decreased from 1.31 in the UC to 0.9 in the 0.3 mg/l Si-MMS treatment group.

No significant chest lesions were observed in the UC group upon rearing on humid bedding material, therefore no improvement could be observed in the treatment groups.

TABLE 7
Footpad and chest lesion scores per treatment group at end of study

| | Footpad lesion | | | | | Chest lesion | | |
|---|---|---|---|---|---|---|---|---|
| Groupname | 0 | 1 | 2 | P | Mean | 0 | 1 | Mean |
| UC | 9 | 16 | 24 | Ref. | 1.31 | 48 | 1 | 0.02 |
| Si-MMST 1 | 19 | 16 | 14 | 0.01 | 0.9 | 48 | 1 | 0.02 |
| Si-MMST 2 | 8 | 27 | 10 | 0.081 | 1.04 | 45 | 0 | 0.00 |

Femur Head Necrosis and Tibia Dyschondroplasy

On D41, all birds were scored for femur head necrosis and tibia dyschondroplasy as described in table 8. No significant differences could be observed between the UC and silicium treated groups based on femur head necrosis and tibia dyschondroplasy.

TABLE 8
Femur head necrosis and tibia dyschondroplasy
scores per treatment group at end of study

| | Femur head | | | | | | | Tibia | | | |
|---|---|---|---|---|---|---|---|---|---|---|---|
| | necrosis | | | | | | | dyschondroplasy | | | |
| Groupname | 0 | 1 | 2 | 3 | 5 | P | Mean | 0 | 1 | 2 | Mean |
| UC | 12 | 11 | 26 | 0 | 0 | Ref. | 1.29 | 43 | 6 | 0 | 0.12 |
| Si-MMST 1 | 10 | 15 | 24 | 0 | 0 | 0.922 | 1.29 | 44 | 5 | 0 | 0.10 |
| Si-MMST 2 | 15 | 7 | 22 | 1 | 0 | 0.665 | 1.2 | 41 | 4 | 0 | 0.09 |

Bone Analysis

On D41, one tibia of each bird was collected for analysis. Initially, we selected 2 birds in each pen (first 2 numbers/pen) to obtain 50 samples for analysis of bone weight, fracture force (N), maximum force (N), stiffness (N/mm), bone dry matter (%), bone ash (%), phosphorus content (%), calcium content (%), copper content (mg/kg), manganese content (mg/kg) and zinc content (mg/kg). The results of bone strength measurement per treatment group are presented in table 9 and analysis on bone composition is represented in table 10.

Differences in fracture force, maximum force and stiffness between the UC and silicium treated groups did not show to be significant. Despite a lack of statistical significance, the inventors believe that such statistical significance would be found with a larger sample size. In particular the improved bone weight, fracture force and stiffness of the treatment group Si-MMST 2 is noted.

TABLE 9
Bone strength measurement

| | Bone | | Fracture | | Maximum | | | |
|---|---|---|---|---|---|---|---|---|
| | weight | | force | | force | | Stiffness | |
| | | p- | | p- | | p- | | p- |
| Groupname | Mean | value | Mean | value | Mean | value | Mean | value |
| UC | 12.7 | Ref. | 333.5 | Ref. | 382.0 | Ref. | 147.9 | Ref. |
| Si-MMST 1 | 12.3 | 0.67 | 360.7 | 0.52 | 372.5 | 0.79 | 148.8 | 0.94 |
| Si-MMST 2 | 13.2 | 0.42 | 400.6 | 0.11 | 409.6 | 0.44 | 164.3 | 0.18 |

Supplementation of silicium to the drinking water of birds did not alter the percentage of dry material or ash in the collected tibia. No significant differences were observed, suggesting that these concentrations of silicium in these formulations could not induce alterations in bone composition.

TABLE 10
Bone composition measurements

| | Dry matter | | Ash | | Calcium | | Phosphorus | | Copper | | Manganese | | Zinc | |
|---|---|---|---|---|---|---|---|---|---|---|---|---|---|---|
| | | p- | | p- | | p- | | p- | mg/ | p- | mg/ | p- | mg/ | p- |
| Groupname | % | value | % | value | % | value | % | value | kg | value | kg | value | kg | value |
| UC | 50.0 | Ref. | 22.6 | Ref. | 35.2 | Ref. | 17.8 | Ref. | 3.4 | Ref. | 7.5 | Ref. | 338.9 | Ref. |
| Si-MMST 1 | 49.0 | 0.442 | 22.6 | 0.941 | 35.3 | 0.962 | 17.8 | 0.738 | 3.3 | 0.674 | 7.4 | 0.903 | 326.9 | 0.378 |
| Si-MMST 2 | 49.1 | 0.488 | 22.9 | 0.6 | 35.1 | 0.541 | 17.6 | 0.123 | 3.2 | 0.552 | 8.2 | 0.308 | 340.3 | 0.918 |

* Values below the detection limit for manganese (<5) were give a value of 2.5

It should be understood that the present invention is in no way limited to the embodiments described above and that many modifications may be made thereto within the scope of the appended claims. Similar results can be expected for other types of poultry, also when deviating feeding regimen are applied.

1. Poultry feed or drinking water composition comprising monomethylsilanetriol (MMST).

2. The poultry feed or drinking water composition according to claim 1, wherein MMST is comprised in drinking water.

3. The poultry feed or drinking water composition according to claim 2, wherein MMST is comprised in drinking water in an amount of 0.05 to 150 mg/l.

4. The poultry feed or drinking water composition according to claim 3, wherein MMST is comprised in drinking water in an amount of 0.1 to 50 mg/l.

5. The poultry feed or drinking water composition according to claim 2, wherein MMST is comprised in drinking water in an amount of 0.15 to 20 mg/l.

6. The poultry feed or drinking water composition according to claim 1, wherein said composition comprises silicon in an amount of 100 μg/kg of composition to 100.000 μg/kg of composition as determined by ICP-AES.

7. The poultry feed or drinking water composition according to claim 1, wherein said composition comprises silicon in an amount of 200 μg/kg of composition to 7000 μg/kg of composition as determined by ICP-AES.

8. The poultry feed or drinking water composition according to claim 1, for improving bone strength in poultry.

9. The poultry feed or drinking water composition according to claim 1 for improving body weight in poultry.

10. The poultry feed or drinking water composition according to claim 1 for improving daily weight increase in poultry.

11. The poultry feed or drinking water composition according to claim 7, whereby said poultry is chicken and whereby said chicken is between 1 and 60 days of age.

12. Method of breeding poultry by feeding to said poultry a feed or drinking water composition comprising monomethylsilanetriol (MMST).

13. The method according to claim 12, wherein MMST is comprised in drinking water.

14. The method according to claim 13, wherein MMST is comprised in drinking water in an amount of 0.05 to 150 mg/l.

15. The method according to claim 12 or 13, wherein said composition comprises silicon in an amount of 100 μg/kg to 7000 μg/kg of composition as determined by ICP-AES.
